(19) United States
(12) Patent Application Publication
(10) Pub. No.: US 2014/0281851 A1
(43) Pub. Date: Sep. 18, 2014

(54) Computer-Readable Storage Device, System and Method of Automatically Generating a Hunt Story

(71) Applicant: John Francis McHale, Austin, TX (US)

(72) Inventor: John Francis McHale, Austin, TX (US)

(21) Appl. No.: 14/213,421

(22) Filed: Mar. 14, 2014

Related U.S. Application Data
(60) Provisional application No. 61/794,972, filed on Mar. 15, 2013.

(51) Int. Cl. G06F 17/21; F41G 1/38

(52) U.S. Cl. CPC G06F 17/211; F41G 1/38
USPC 715/202

(57) ABSTRACT

A computer-readable storage device embodies instructions that, when executed by a processor, cause the processor to receive data from a rifle scope corresponding to a hunt. Further, the instructions cause the processor to automatically generate a story corresponding to the hunt based on the data from the rifle scope and provide the story to an output interface.

### CROSS-REFERENCE TO RELATED APPLICATION(S)

This application is a non-provisional of and claims priority to U.S. Provisional patent application No. 61/794,972 filed on Mar. 15, 2013 and entitled “Computer-Readable Storage Device, System and Method of Automatically Generating a Hunt Story,” which is incorporated herein by reference in its entirety.

### FIELD

The present disclosure is generally related to automatic story generation systems.

### BACKGROUND

Social media servers allow users to upload and share media content, such as images, short videos, text, and audio content. In some instances, users may associate text with such media content, providing context and/or labels for the media content. In an example, a user may consolidate such media content into a photo album or slide-show to produce a “story” that can be viewed and understood by others.

### SUMMARY

In an embodiment, a computer-readable storage device embodies instructions that, when executed by a processor, cause the processor to receive data from a rifle scope corresponding to a hunt. Further, the instructions cause the processor to automatically generate a story corresponding to the hunt based on the data from the rifle scope and provide the story to an output interface.

In another embodiment, a method includes receiving data from a rifle scope corresponding to a hunt. The method further includes automatically generating a story corresponding to the hunt based on the data from the rifle scope and providing the story to an output interface.

In still another embodiment, a system includes an interface configured to receive media data corresponding to a hunt, a display, a processor coupled to the interface and the display, and a memory accessible to the processor. The memory is configured to store instructions that, when executed by the processor, cause the processor to automatically generate a hunt story based on the media data and to provide the hunt story to the display.

### BRIEF DESCRIPTION OF THE DRAWINGS

FIG. 1 is a block diagram of an embodiment of a system configured to automatically generate a hunt story.

FIG. 2 is a block diagram of an embodiment of an optical device configured to provide data to generate a hunt story.

FIG. 3 is a block diagram of an embodiment of a computing device configured to generate a hunt story.

FIG. 4 is a flow diagram of a method of automatically generating a hunt story according to an embodiment.

In the following discussion, the same reference numbers are used in the various embodiments to indicate the same or similar elements.

### DETAILED DESCRIPTION OF ILLUSTRATIVE EMBODIMENTS

In the following detailed description of the embodiments, reference is made to the accompanying drawings which form a part hereof, and in which are shown by way of illustration of specific embodiments. It is to be understood that other embodiments may be utilized and structural changes may be made without departing from the scope of the present disclosure.

Embodiments of a hunt story generation system and method are described below that include an optical device, such as a rifle scope, that is configured to capture images and/or video data associated with a hunting experience and to communicate media data including the images, video data, audio data, text data, or any combination thereof to a computing device. The computing device receives the media data, retrieves related data corresponding to the dates and times that the media data was collected and automatically generates a hunt story based on the media data and the related data. An embodiment of a system configured to automatically generate a hunt story is described below with respect to FIG. 1.

FIG. 1 is a block diagram of an embodiment of a system 100 configured to automatically generate a hunt story. System 100 includes a firearm system 102 configured to communicate with one of a computing device 104 and a network 106 through a wireless communication link. System 100 further includes a server 108 that is coupled to network 106.

Firearm system 102 includes a rifle scope 110 including a circuit 112 that is configured to collect data corresponding to a hunt and to communicate the media data to one of computing device 104 and network 106. Rifle scope 110 is coupled to a firearm 114. It should be understood that rifle scope 110 is one possible implementation of an optical device configured to capture media data and to communicate the media data. In another embodiment, the optical device may be implemented as a pair of binoculars or another type of portable optical device.

Computing device 104 may be a smart phone, laptop, tablet, or other computing device configurable to communicate wirelessly with circuit 112 in rifle scope 110 and to communicate with a network 106. Computing device 104 includes a touchscreen interface 116 configured to display information and to receive user input. Computing device 104 includes a processor configured to execute instructions stored in a memory of computing device 104. In an embodiment, computing device 104 may include a hunt story application 118 that may be executed by the processor to automatically gather data from a variety of data sources to assemble a hunt story. Computing device 104 may further include a global positioning satellite (GPS) circuit 120. Computing device 104 may communicate with server 108, other computing devices 132, and/or circuit 112 through network 106. Computing device 104 may also communicate directly with circuit 112 through a communications link, such as a Bluetooth® or other short-range wireless communications link.

Network 106 may be a communications network, such as the Internet, a cellular, digital, or satellite communications, network, or any wide area communications network. In an embodiment, circuit 112 within rifle scope 110 may include a wireless transceiver configured to communicate with a wireless access point or base station to communicate media data to other devices, through network 106, such as server 108, computing device 104, or user devices 132.

Server 108 may include a social media server application 122 that may be executed by a processor of the server to provide a social media server that receives data from subscribers, stores the data in a social media content database 124, and selectively publishes data from subscribers to allow limited access to the data by other subscribers. Server 108 further includes a hunt story application 126 that may be executed by a processor of server 108, causing the processor to receive data from circuit 112 of rifle scope 110 and/or from computing device 104 and to store the data in temporary tables 130. Hunt story application 126 may also cause the processor to select a suitable hunt story template from a plurality of hunt story templates 128. Each story template may define an arrangement of text, images and/or video content to produce a presentation or story that includes information related to the hunting expedition.

In an embodiment, a shooter may carry firearm system 102 and computing device 104 on a hunt. For example, computing device 104 may be a smart phone carried by the shooter in his/her pocket. Over a period of time that includes the hunt, GPS circuit 120 of computing device 104 (or a GPS circuit within rifle scope 110) may collect location data and associated timestamps and may store the location data and timestamps in a memory. Additionally, when the rifle scope 110 is activated by the user, rifle scope 110 may capture images and/or video of the view area of the rifle scope 110, including a selected target and images/video of shots taken by the shooter together with associated time information. Rifle scope 110 may store the images and/or video data and associated timestamps in memory.

A user may activate hunt story application 118, which causes a processor of computing device 104 to communicate with circuit 112 to retrieve the images and/or video data from circuit 112 and correlate the images and/or video data to GPS data based on the associated time stamps. In an embodiment, hunt story application 118 may utilize the retrieved images/video data and GPS data to automatically generate a hunt story and a chronology that may be shared with others via server 108 or directly using a social media application, such as email. In another embodiment, hunt story application 118 may send the retrieved images/video data and GPS data to server 108, which may store the images/video data and GPS data in temporary tables 130. Hunt story application 118 may then select one of a plurality of hunt story templates 128 and populate the selected template using the stored images/video data, the GPS data, and other data to produce a hunt story. The hunt story may then be downloaded to computing device 104 to view and/or to upload to server 108 and share with others. Alternatively, the hunt story may be stored in social media content 124 and associated to an account that corresponds to the user.

In an embodiment, hunt story application 118 in computing device 104 or hunt story application 126 in server 108 may retrieve information related to the GPS data and times corresponding to the hunt. Such related information can include geographical information, topographical information, weather information and so on, which related information can add details to the hunt story. In an example, the hunt story may be a travel narrative, tracing the shooter's movements from a starting point to the location where the shot was fired and to the prey location and then back to the user's starting point. The travel narrative includes chronological information and can include details about the weather and the terrain. Additionally, the hunt story may include information about nearby landmarks and other geographic items of interest.

In an embodiment, the generated hunt story may be presented to the user on display interface 116 of computing device 104 or on some other computing device. The user may interact with the associated input interface to upload and insert additional photographs (such as images captured by computing device 104 or a digital camera, and/or from rifle scope 110) and to edit the narrative to include other details about the adventure and other details about the shot taken by the user. The edited hunt story may then be uploaded to server 108 and stored in social media content 124 to be shared with other users. Alternatively and/or in addition, the edited hunt story may be stored locally, in a memory of computing device 104, and shared via email or through print media.

In some embodiments, circuitry 112 of rifle scope 110 may include GPS circuitry, video capture circuitry, and a processor configured to execute a hunt story application. In one embodiment, the hunt story application within rifle scope 110 may consolidate the captured data and provide it to computing device 104 for generation of the story. In another embodiment, the hunt story application within rifle scope 110 may generate the initial version of the hunt story and then share the version with computing device 104 for editing by the user. An embodiment of circuitry 112 within rifle scope 110 is described below with respect to FIG. 2.

FIG. 2 is a block diagram of an embodiment of an optical device 200 configured to provide data to generate a hunt story. Optical device 200 may include circuitry 112, such as circuit 112 within rifle scope 110. Circuitry 112 may be coupled to firearm 114, such as to buttons on the firearm or to a trigger assembly, and to user-selectable input elements 204, such as buttons or rockers on a housing of optical device 200. Further, circuitry 112 may be configured to communicate with computing device 104 through a wireless communication link.

Circuitry 112 includes a processor 208 coupled to a memory 210 that is configured to store processor-executable instructions, images, applications, video, and other data. Further, processor 208 is coupled to a compass (directional) sensor 206, which can provide directional data to processor 208. Processor 208 is also coupled to image sensors 212 configured to capture video data corresponding to a view area 202, and the processor 208 is further coupled to a display 214. Processor 208 is also coupled to an input interface 216 configured to receive user inputs from user-selectable input elements 204. Processor 208 is also coupled to laser range finding circuit 218, which controls a laser interface 220 to direct a beam toward a selected target and one or more LRF optical sensors 222 to capture reflected versions of the beam. In an alternative embodiment, image sensors 212 may be used to capture the reflected version of the beam.

Processor 208 is also coupled to motion sensors 224, which may include one or more inclinometers 230, one or more gyroscopes 232, one or more accelerometers 234, and other motion sensor circuitry 236. Processor 208 may also be coupled to one or more environmental sensors (such as temperature sensors, barometric sensors, wind sensors, and so on, which are not shown). Processor 208 may utilize the incline data from inclinometers 230 and orientation data from gyroscopes 232 and accelerometers 234, in conjunction with directional data from compass (directional) sensor 206 to gather data about the direction, position, and orientation of the rifle scope during a hunting expedition. Processor 208 is also coupled to transceiver 226, which is configured to communicate data to and receive data from computing device 104 through a wireless communication link. Further, processor 208 is coupled to firearm interface 228, which is configured to receive signals from components of firearm 114. Additionally, processor 208 may be coupled to a GPS circuit 260.

Memory 210 is configured to store instructions that, when executed by processor 208, cause processor 208 to process image data, to present at least a portion of the image data to display 214, and to perform some operations relating to automatic generation of a hunt story. Memory 210 includes user input logic instructions 238 that, when executed, cause processor 208 to respond to user input received from firearm interface 228 and from input interface 216 and to interpret the input and respond accordingly. Memory 210 further includes image processing logic instructions 240 that, when executed, cause processor 208 to process video frames captured by image sensors 212 and to present at least a portion of the video data to the display 214.

Memory 210 includes heads up display (HUD) generator instructions 242 that, when executed, cause processor 208 to generate a display interface that may overlay the portion of the video data provided to display 214. Memory 210 also includes hunt story data gathering application 244 that, when executed, cause processor 208 to capture data including image/video data 246 (and associated timestamps), location data 248 (such as GPS data and associated timestamps), and motion/incline data 250, which data may be used as details within an automatically generated hunt story.

In an embodiment, GPS circuit 260 captures GPS data when circuitry 112 is activated and continuously (or periodically) thereafter and processor 208 stores the GPS coordinates as location data 248 in memory 210. Further, processor 208 stores at least some image and/or video data as image/video data 246 in memory 210 and stores motion sensor data as motion/incline data 250. In response to a signal from computing device 104, processor 208 executes hunt story data gathering application 244, which bundles the image/video data 246, location data 248, and motion/incline data 250 and sends the bundled data to computing device 104 via transceiver 226. Alternatively, transceiver 226 may communicate with network 106 and communicate the bundled data either to computing device 104 or server 108. Computing device 104 or server 108 may then process the bundled data to automatically generate a hunt story. In yet another embodiment, the processor 208 automatically generates the hunt story without the user triggering the application.

In an alternative embodiment, memory 210 may store a hunt story application, such as hunt story application 118 and may include one or more hunt story templates, which can be used by processor 208 to automatically generate a hunt story based on the image/video data 246, location data 248, and motion/incline data 250. The generated hunt story may then be communicated to computing device 104 or to network 106 via transceiver 226. In an embodiment, the user may then edit the generated hunt story using interface 116 of computing device 104 (or an input interface of some other computing device, smart phone, or data processing device) before sharing the hunt story with others. In an embodiment, circuitry 112 may also include a microphone and analog-to-digital converter (such as ADC 312 in FIG. 3) configured to receive audio information (such as narration) from a user, which may be stored in memory 210 and which may be provided to computing device 104 together with the image/video data and other information for incorporation within the automatically generated hunt story. One possible embodiment of a computing device 104 is described below with respect to FIG. 3.

FIG. 3 is a block diagram of an embodiment of a computing device 104 configured to generate a hunt story. Computing device 104 includes a processor 302 coupled to a memory 304, to a network transceiver 306 configured to communicate data to and from network 106, and to a short-range transceiver 308 configured to communicate data to and from an optical device, such as rifle scope 110. Processor 302 is also coupled to a microphone 310 through an analog-to-digital converter (ADC) 312 and to a speaker 314 through a digital-to-analog converter 316. Further, processor 302 is coupled to display interface 116, which includes a display component 320 and an input interface 322, which may be combined to form a touchscreen interface. Computing device 104 may also include a GPS circuit 120 coupled to processor 302.

Memory 304 is a computer-readable storage device configured to store processor-executable instructions and data. Memory 304 includes browser instructions 324 (such as an Internet browser application) that, when executed, causes processor 302 to generate a graphical user interface through which a user may access web sites and data sources through network 106. Memory 304 also includes other applications 326 that may be executed by a user, such as calendar applications, games, and so on. Memory 304 further includes a hunt story application 332 that, when executed, causes processor 302 to retrieve images/video and/or other data from rifle scope 110, to gather GPS data from rifle scope 110 or GPS circuit 120, and optionally to receive audio data, either from rifle scope 110 or from microphone 310. Hunt story application 332 may store the data in hunt story data 336, may retrieve a selected hunt story template from a plurality of hunt story templates 334 in memory 304, and may automatically generate a hunt story based on the selected template and the hunt story data.

In an embodiment, computing device 104 receives hunt story data from rifle scope 110. The data may be received continuously or periodically during a hunt, or may be retrieved in response to the user executing the hunt story application 332. The received data may be processed by processor 302 to associate images, video and other data in chronological order, associating time-related pieces of data. Further, computing device 104 may automatically retrieve geographical information, weather information, and other data from one or more data sources through network 106 and correlate the retrieved data to the date/time and location data in order to add details to the hunt story.

In an example, computing device 104 may receive media data (images, video, incline/motion, environmental data, and/or location data) from rifle scope 110. In some embodiments, location data may also be determined from GPS circuit 120 in computing device 104. Computing device 104 may process the location, date, and time data to extract details that can be used to generate one or more queries to various data sources. In an example, computing device 104 may use the extracted data to retrieve weather conditions and geographical information from one or more data sources through network 106 that correspond to the date, time, and location data within the media data. Computing device 104 may correlate the retrieved data to the media data and populate a template with a chronological arrangement of the hunt information, automatically producing a travel/adventure narrative that includes pictures from rifle scope 110, text about the shooter's movements during the hunt, shot details, weather conditions, and the like. The hunt story application 332 may then cause processor 302 to present the hunt story to user interface 116 and allow the user to edit the hunt story, including adding a title, changing or adding to the text, introducing captions to the pictures, and so on.

In a particular example, the generated hunt story may begin, “Oct. 20, 2012 was a cold and damp Saturday in the Black Hills of South Dakota. It had rained the night before. My morning started in Hill City, and we headed south . . . .” The details may have been retrieved from weather sites based on the date and time and the city and directional information may have been retrieved based on GPS coordinates. Further details may then be added or changed by the user based on the generated text. The hunt story may then be stored in memory 304 and/or uploaded to server 108 through network 106.

Depending on the template, the format of the hunt story may vary. For example, pictures may be presented on the left or right or may be centered (or any combination thereof). Text may wrap around the images or may end above a picture and resume below the picture. Maps and other data may also be included, producing a relatively detailed adventure narrative, including (in the case of a successful hunt) an image of the selected prey and the shot taken by the shooter. Various template styles may be selected or may be downloaded from server 108, depending on the implementation.

In general, the hunt story application 332 may be provided as a downloadable application or may be provided on a thumb drive or other data storage device, such as a compact disc. Similarly, the hunt story templates 334 may be provided with the hunt story application 332 or may be provided separately, either via download or via a storage device. Hunt story application 332 allows the user to generate, view, and edit a hunt story to produce a desired narrative. In some examples, the user may import additional photographs, maps, or other information that can also be incorporated into the story to produce a complete narrative. By automating the hunt story generation, the shooter may capture details of a particular hunt that might otherwise be forgotten, particularly if the shooter tries to assemble the details at a later time from his/her own memory. Additionally, because rifle scope 110 can capture images of the selected target and the shot and/or capture video of the event, the hunt experience can be shared with friends, and the hunt story can provide at least a preliminary outline of the experience that the user may edit to further enhance the shared experience.

In an alternative embodiment, computing device 104 may provide the media data to server 108, and hunt story application 126 or 332 executing on server 108 may generate the hunt story, using a selected one of hunt story templates 128 or 334. In still another embodiment, whether on computing device 104 or server 108, the user may include audio narrative (which may have been captured live by the shooter via a microphone of computing device 104 or via a microphone (not shown) within circuit 112 of rifle scope 110). Alternatively, the user may record and upload audio data for inclusion with the hunt story at a later time. Thus, hunt story application 332 or 126 may produce a hunt story or narrative about a particular hunt experience based on the collected images and data and according to a selected template. The resulting story captures at least the measurable and captured details of the hunt experience to which the user may add further details to produce a complete hunt story that can be shared with others.

While the above-discussion has focused on the structure and systems that may be configured to automatically generate a hunt story, it should be understood that any number of different systems may interact to produce the hunt story, including optical devices, computing devices and so on. The data from the rifle scope 110 may be combined with other information from various sources and using one or more processors of one or more different systems to generate and share the hunt story.

It should be understood that the hunt story may be automatically generated by server 108 or by computing device 104. In a particular embodiment, the hunt story application and GPS circuit 260 within circuitry 112 may be used by processor 208 to generate the hunt story within rifle scope 110. One possible method of automatically generating a hunt story using a computing device, such as computing device 104 or server 108, is described below with respect to FIG. 4.

FIG. 4 is a flow diagram of a method 400 of automatically generating a hunt story according to an embodiment. At 402, media data corresponding to a hunt is received at a computing device, such as server 108 or computing device 104. Advancing to 404, location data and timing data are received that correspond to the media data. In a particular example, the location data may be received from rifle scope 110 or from GPS circuit 120 within computing device 104.

Proceeding to 406, the computing device optionally retrieves related data from one or more data sources corresponding to at least one of the location data and the timing data. The related information may include geographical information as well as weather conditions and other information. Advancing to 408, the computing device selects one of a plurality of hunt story templates. In a particular example, the computing device may include a default template and a second template, and computing device may automatically select the default template. In another example, the computing device may present one or more template options to the user, including the option to download and/or select other templates. Alternatively, the user may create a template that has been customized to that user's desired formatting.

Continuing to 410, a hunt story is automatically generated based on the selected hunt story template and including the media data, the location data, and timing data, and the related data. Proceeding to 412, the hunt story is stored in a memory. Moving to 414, the hunt story is selectively provided to one of a display and a user device. In an example, if the computing device 104 is generating the hunt story, computing device 104 provides the hunt story to display 320. In another example, if server 108 is generating the hunt story, server 108 may provide the hunt story to computing device 104 through network 106.

Advancing to 416, a user input corresponding to the hunt story is received. In an example, the user input is received via input interface 322. Proceeding to 418, the hunt story is modified according to the user input. For example, the user may move images, embed additional images and/or video, add or change text, and so on. The resulting hunt story may then be stored in memory and/or shared with other users.

In conjunction with the systems, circuits and methods described above with respect to FIGS. 1-4, a hunt story application is described that is configured to receive media data (including images, video, audio, text, sensor information, or any combination thereof) from components of a rifle scope and or from components of a computing device. The hunt story application uses the data to populate a selected hunt story template to produce a hunt story. In some embodiments, the hunt story application is used to process the media data into a chronological order. Further, the hunt story application is used to extract date/time and location data from the media data (or from the GPS data provided by GPS circuit 120 of computing device 104), to generate one or more queries of other data sources based on the date/time and location data, to retrieve related data based on the one or more queries, and to correlate the retrieved data to the media data. The retrieved data may then be included within the hunt story to produce an adventure story complete with pictures and related details that can be shared with others.

Although the present invention has been described with reference to preferred embodiments, workers skilled in the art will recognize that changes may be made in form and detail without departing from the scope of the invention.

What is claimed is:

1. A computer-readable storage device embodying instructions that, when executed by a processor, cause the processor to:
receive data from a rifle scope corresponding to a hunt;
automatically generate a story corresponding to the hunt based on the data from the rifle scope; and
provide the story to an output interface.

2. The computer-readable storage device of claim 1, wherein the output interface comprises at least one of a display interface coupled to a display and a network interface configured to couple to a network.

3. The computer-readable storage device of claim 1, wherein the data from the rifle scope comprises at least one of a first image of a target within a view area of the rifle scope, a second image of the target within the view area when a shot was fired, and video data including the target within the view area.

4. The computer-readable storage device of claim 1, wherein the data comprises location data and date and time data.

5. The computer-readable storage device of claim 4, wherein the instructions further include instructions that, when executed, cause the processor to retrieve location data, weather data, and other related data based on the data from the rifle scope and to incorporate the location data, the weather data, and the other related data into the story.

6. The computer-readable storage device of claim 1, wherein the instructions further include instructions that, when executed, cause the processor to receive user input to edit the story.

7. The computer-readable storage device of claim 1, wherein the instructions further include instructions that, when executed, cause the processor to receive one of text data and audio data for inclusion within the story.

8. A method comprising:
receiving data from a rifle scope corresponding to a hunt;
automatically generating a story corresponding to the hunt based on the data from the rifle scope; and
providing the story to an output interface.

9. The method of claim 8, wherein receiving the data comprises receiving image data, location data, date data, time data, and other data corresponding to the hunt.

10. The method of claim 9, wherein the location data includes global positioning satellite (GPS) data corresponding to a first location where the rifle scope was powered on through a last location where the rifle scope was powered off.

11. The method of claim 9, wherein automatically generating the story comprises retrieving information related to the location data and corresponding to the date data and the time data and including the information in the story.

12. The method of claim 11, wherein the information includes at least one of weather data and elevation data corresponding to the location data, the date data and the time data.

13. The method of claim 8, wherein the data from the rifle scope includes image data including a target within a view area of the scope and range data corresponding to a distance between the rifle scope and the target.

14. The method of claim 8, wherein providing the story to the output interface comprises providing the story to a display, and wherein the method further includes:
providing one or more user-selectable options to the output interface; and
receiving a user input corresponding to one or more of the user-selectable options to edit the story.

15. A system comprising:
an interface configured to receive media data corresponding to a hunt;
a display;
a processor coupled to the interface and the display; and
a memory accessible to the processor and configured to store instructions that, when executed by the processor, cause the processor to automatically generate a hunt story based on the media data and to provide the hunt story to the display.

16. The system of claim 15, wherein the memory further includes instructions that, when executed, cause the processor to receive user input corresponding to the hunt story and to modify the hunt story based on the user input.

17. The system of claim 15, wherein the memory further includes instructions that, when executed, cause the processor to retrieve data related to the media data and to assemble the media data and the retrieved data into a story template to produce the hunt story.

18. The system of claim 17, wherein the media data includes at least one of an image, a video clip, and location data corresponding to a path traveled by a rifle scope.

19. The system of claim 17, wherein the retrieved data includes elevation data, weather data, and other information corresponding to the media data.

20. The system of claim 15, wherein the system comprises one of a smart phone, a laptop computer, and a tablet computer.
